(19) United States
(12) Patent Application Publication
(10) Pub. No.: US 2021/0041656 A1
(43) Pub. Date: Feb. 11, 2021

(54) OPTICAL ELEMENT, OPTICAL SYSTEM, AND IMAGING DEVICE

(71) Applicant: AGC Inc., Tokyo (JP)

(72) Inventors: Koji MIYASAKA, Tokyo (JP); Hiromasa SATO, Tokyo (JP)

(73) Assignee: AGC Inc., Tokyo (JP)

(21) Appl. No.: 17/076,900

(22) Filed: Oct. 22, 2020

Related U.S. Application Data
(63) Continuation of application No. PCT/JP2019/016908, filed on Apr. 19, 2019.

(30) Foreign Application Priority Data
Apr. 24, 2018 (JP) 2018-083225

(51) Int. Cl. G02B 7/02; G02B 1/11

(52) U.S. Cl. CPC G02B 7/022; G02B 7/021; G02B 1/11

(57) ABSTRACT

An optical element includes: an optical function part; a flange disposed outside the optical function part; and a direction indication part in a part of the flange. A difference in level between the direction indication part and a flat surface of the flange is 2 μm or less. The optical function part and a part of the flange may be covered with an antireflection film.

### TECHNICAL FIELD

The present invention relates to an optical element, an optical system, and an imaging device.

### BACKGROUND ART

A lens unit used as a camera in cell phones (including smartphones) or a camera mounted on vehicles is typically formed such that a plurality of lens elements stacked in a lens barrel in the optical-axis direction. It is necessary to assemble the lens unit such that the optical axis of each lens element does not deviate from the central axis of the lens barrel (such that an offset in optical axis does not occur).

Patent Literature 1 describes an assembly method in which one lens element and another lens element each having a circularly formed portion for fitting with the other are stacked in such a manner that the two lens elements are positioned, while rotating the one lens element with respect to the other lens element, so as not to result in an offset in axis.

By the assembly method described in Patent Literature 1, the positions where two lens elements are to be disposed without causing an offset in axis can be determined even when the aberration and eccentric direction of each lens element are unknown. However, a larger number of steps are necessary for stacking the lens elements. In the case where the aberration and eccentric direction of each of the two lens elements are known, use of another assembly method is advantageous.

Glass has higher stability (e.g., heat resistance and hardness) than synthetic resins. In the case of lens elements made of glass, it is effective to form a mark for positioning the lens elements without causing an offset in axis.

Patent Literature 2 describes a lens element to be incorporated into a lens barrel (holder). The lens element described in Patent Literature 2 includes an optical function part which functions optically, a doughnut-shaped flange disposed outside the periphery of the optical function part, and a mark. The mark is formed on the flange. Specifically, the mark is formed so as to protrude from one portion of the periphery of the optical function part onto a flange surface (a surface of the flange). The flange is attached to the lens barrel, and when the flange is attached, the attachment position of the lens element (attachment position along the direction of the circumference in which the optical axis is set as the center) is determined.

### CITATION LIST

### Patent Literature

Patent Literature 1: Japanese Patent No. 5204591

Patent Literature 2: Japanese Patent No. 4404914

### SUMMARY OF INVENTION

### Technical Problem

In the case where a mark is provided to a lens element made of glass and the mark is one which protrudes sharply or has a large height, the lens element is likely to chip when the lens element is molded or when a lens unit containing the lens element is used.

Meanwhile, there are cases where a lens unit is produced such that a lens element made of glass is in contact with other members (e.g., the lens barrel, a surface of the flange of another lens element, and a spacer element).

In such cases, it may be undesirable to form a protruding mark, such as that described in Patent Literature 2, on the flange of the lens element. This is because surfaces of the lens element which come into contact with other members are required to be flat for preventing the lens unit from decreasing in performance, and there is a possibility that the protruding mark might cause a tilt to the flange surface of the lens element when the lens element comes into contact with another member. For example, in the case where the flange of a lens element is inserted into a recess formed in a lens barrel, the flatness of the flange surface may be impaired if the mark comes into contact with the lens barrel, etc.

FIG. 7 is a cross-sectional view showing an example of the state of a lens element 70 incorporated into a lens barrel 80. In the example shown in FIG. 7, the lens element 70 includes a mark 72 disposed so as to protrude from one portion of the periphery of an optical function part 71 onto a flange 73. Only a part of the lens element 70 is shown in FIG. 7. When the lens element 70 is incorporated into the lens barrel 80, the flange 73, which is integrally formed with the mark 72, deforms if the mark 72 comes into contact with the lens barrel 80. As a result, the flatness of the flange surfaces is impaired.

An object of the present invention is to provide an optical element which is inhibited from decreasing in flange-surface flatness even when coming into contact with other members and to provide an optical system including the optical element and an imaging device including the optical element.

### Solution to Problem

The optical element in the present invention includes an optical function part, a flange disposed outside the optical function part and a direction indication part in a part of the flange, in which a difference in level between the direction indication part and a flat surface of the flange is 2 μm or less. The expression “outside the optical function part” indicates a region outside the periphery of the optical function part, the region including an area adjoining the optical function part and an area separated from the optical function part. The term “flat surface of the flange” means a region of a surface of the flange (flange surface) which does not include the direction indication part.

The optical system in the present invention includes the optical element.

The imaging device in the present invention includes the optical element.

### Advantageous Effect of Invention

In the present invention, the optical element is inhibited from decreasing in flange-surface flatness even when coming into contact with other members.

### BRIEF DESCRIPTION OF DRAWINGS

FIG. 1 is a view showing an optical element according to a first embodiment.

FIG. 2 is a cross-sectional view showing a lens unit including a lens barrel into which the optical element according to the first embodiment is incorporated.

FIG. 3 is a view showing an optical element according to a second embodiment.

FIG. 4 is a cross-sectional view showing a lens unit including a lens barrel into which the optical element according to the second embodiment is incorporated.

FIG. 5 is a view showing an optical element according to a third embodiment.

FIG. 6 is a cross-sectional view showing a lens unit including a lens barrel into which the optical element according to the third embodiment is incorporated.

FIG. 7 is a cross-sectional view showing an example of the state of a lens element incorporated into a lens barrel.

### DESCRIPTION OF EMBODIMENTS

Embodiments of the present invention are explained below by reference to the drawings.

### Embodiment 1

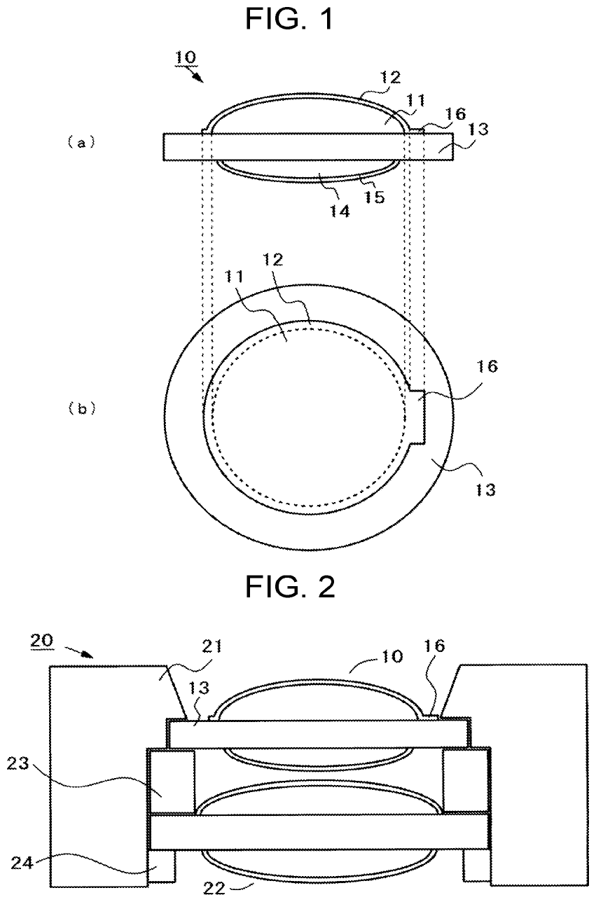

FIG. 1 is a view showing an optical element 10 according to a first embodiment. (a) of FIG. 1 is a cross-sectional view and (b) of FIG. 1 is a plan view of the optical element 10 viewed from above.

The optical element 10 is a lens element made of glass. The optical element 10, in a central portion thereof, includes a first curved part (optical function part) 11 having a convex shape, and a second curved part (optical function part) 14, which faces the first curved part 11. A surface of the first curved part 11 is covered with an antireflection film 12. A surface of the second curved part 14 is covered with an antireflection film 15.

The optical element 10 includes a flange 13 disposed outside the optical function part. The antireflection film 12 also covers a part of the flange 13. The antireflection film 12 which covers a part of the flange 13 includes, in a part of the antireflection film 12, a direction indication part 16 which protrudes in the plan-view radial direction (has a quadrilateral shape in the example shown in FIG. 1). The direction indication part 16 performs the same function as the aforementioned mark.

That is, the direction indication part 16 has been disposed such that the worker, when assembling a lens unit, can understand the position of the optical element 10 (attachment position along the direction of the circumference in which the optical axis is set as the center) which does not result in a deviation of the optical axis of the optical element 10 from the axis of the lens barrel.

In this embodiment, the antireflection film 12 is formed such that the proportion of a region of the surface of the flange 13 which is covered with the antireflection film 12 to the region (specifically, the area of the region) of the surface of the flange 13 (including both the portion covered with the antireflection film 12 and the portion not covered therewith) is 40% or less. Namely, the proportion of the region not covered with the antireflection film 12 is 60% or higher.

It is thought that in the case where the proportion of the region not covered with the antireflection film 12 is 60% or higher, flange-surface flatness can be maintained. In the case where the flatness decreases, the optical element 10 is likely to incline with respect to the proper attachment position in incorporating the optical element 10 into a lens barrel, for example. In the case where the optical element 10 inclines, the optical axis of the lens element deviates from the axis of the lens barrel.

It is preferable that the thickness of the direction indication part 16 is, for example, 2 μm or less such that no tilt is caused in the flange surface even if the direction indication part 16 comes into contact with other members (e.g., the lens barrel, a surface of the flange of another lens element, and a spacer element) in assembling a lens unit. The flange 13 is formed such that the surface thereof is flat. In other words, it is hence preferable that the difference in surface level between the direction indication part 16 and the flat surface of the flange 13 (flange surface) is 2 μm or less.

Although the direction indication part 16 shown as an example in FIG. 1 is quadrilateral, the shape of the direction indication part 16 may not be quadrilateral as long as 60% or more of the direction indication part 16 is not covered with the antireflection film 12 and as the worker can visually recognize the direction indication part 16. For example, the direction indication part 16 may have an island shape.

FIG. 2 is a cross-sectional view showing a lens unit 20 including a lens barrel 21 and the optical element 10 incorporated thereinto. The lens unit 20 shown in FIG. 2 includes both the optical element 10 and another lens 22. The optical element 10 is held by the lens barrel 21 and a spacer 23. The lens 22 is held by the lens barrel 21, the spacer 23, and a fastener 24. In FIG. 2, the optical element 10 and the lens 22 are shown as if these are separated from the lens barrel 21 and the spacer 23. Actually, however, the flange 13 of the optical element 10 and the flange of the lens 22 are each in contact with the inner wall of the lens barrel 21. The flange 13 of the optical element 10 is also in contact with the spacer 23. The flange of the lens 22 is also in contact with the fastener 24.

The optical element 10 is to be positioned when the flange 13 comes into contact with the lens barrel 21, etc. The worker understands the circumferential-direction attachment position of the optical element 10 on the basis of the direction indication part 16. Since the flange surface has sufficient flatness in incorporating the optical element 10 into the lens barrel 21 as described above, the flange surface is inhibited from being tilted.

### Embodiment 2

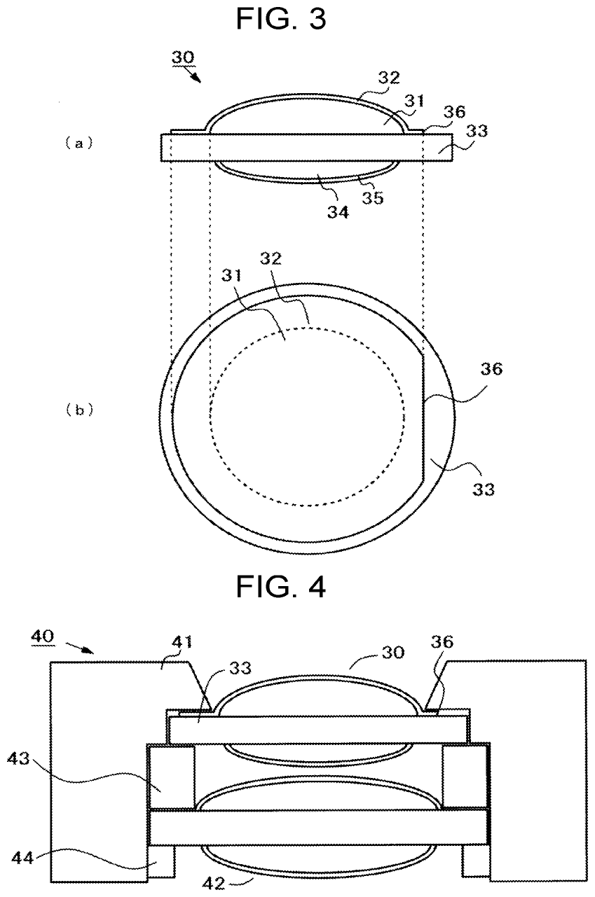

FIG. 3 is a view showing an optical element 30 according to a second embodiment. (a) of FIG. 3 is a cross-sectional view and (b) of FIG. 3 is a plan view of the optical element 30 viewed from above.

The optical element 30 is a lens element made of glass. The optical element 30, in a central portion thereof, includes a first curved part (optical function part) 31 having a convex shape, and a second curved part (optical function part) 34, which faces the first curved part 31. A surface of the first curved part 31 is covered with an antireflection film 32. A surface of the second curved part 34 is covered with an antireflection film 35.

The optical element 30 includes a flange 33 disposed outside the optical function part. In the first embodiment, the flatness of the flange surface is enhanced by reducing the proportion of the region of the antireflection film 12 which covers the flange 13. Meanwhile, in the second embodiment, the flatness of the flange surface (in this embodiment, to be exact, the flange surface indicates a surface of the antireflection film 32 which lies on the flange 33) is enhanced by increasing the proportion of the region of the antireflection film 32 which covers the flange 33. In this embodiment, the region of the flange 33 which underlies the antireflection film 32 is referred to as “covered region”. The region of the flange 33 which is not covered with the antireflection film 32 is referred to as “uncovered region”.

In this embodiment, the proportion of the covered region to the surface of the flange 33 (including both the portion covered with the antireflection film 32 and the portion not covered therewith) is 60% or higher.

It is thought that in the case where the proportion of the covered region is 60% or higher, flange-surface flatness can be maintained. As described above, in the case where the flatness decreases, the optical element 30 is likely to incline with respect to the proper attachment position in incorporating the optical element 30 into a lens barrel, for example. In the case where the optical element 30 inclines, the optical axis of the lens element deviates from the axis of the lens barrel.

A cutout in a part of the doughnut-shaped region of the antireflection film 32 which covers the flange 33 constitutes a direction indication part 36.

It is preferable that the thickness of the direction indication part 36 is, for example, 2 μm or less such that no tilt is caused in the flange surface even if the direction indication part 36 comes into contact with other members (e.g., the lens barrel, a surface of the flange of another lens element, and a spacer element) in assembling a lens unit. The flange 33 is formed such that the surface thereof is flat, and the antireflection film 32 is formed such that the antireflection film 32 having an even thickness covers the flange 33. Consequently, in other words, it is preferable that the difference in surface level between the direction indication part 36 (specifically, a top surface of the direction indication part 36) and the flat portion (flange surface) is 2 μm or less.

Although the direction indication part 36 shown as an example in FIG. 3 has a cutout shape, the direction indication part 36 may have another shape as long as the proportion of the covered region is 60% or higher and as the worker can visually recognize the direction indication part 36. For example, the direction indication part 36 may have an island shape.

FIG. 4 is a cross-sectional view showing a lens unit 40 including a lens barrel 41 and the optical element 30 incorporated thereinto. The lens unit 40 shown in FIG. 4 includes both the optical element 30 and another lens 42. The optical element 30 is held by the lens barrel 41 and a spacer 43. The lens 42 is held by the lens barrel 41, the spacer 43, and a fastener 44. In FIG. 4, the optical element 30 and the lens 42 are shown as if these are separated from the lens barrel 41 and the spacer 43. Actually, however, the flange 33 of the optical element 30 and the flange of the lens 42 are each in contact with the inner wall of the lens barrel 41. The flange 33 of the optical element 30 is also in contact with the spacer 43. The flange of the lens 42 is also in contact with the fastener 44.

The optical element 30 is to be positioned when the flange 33 comes into contact with the lens barrel 41, etc. The worker understands the circumferential-direction attachment position of the optical element 30 on the basis of the direction indication part 46. Since the flange surface has sufficient flatness in incorporating the optical element 30 into the lens barrel 41 as described above, the flange surface is inhibited from being tilted.

### Embodiment 3

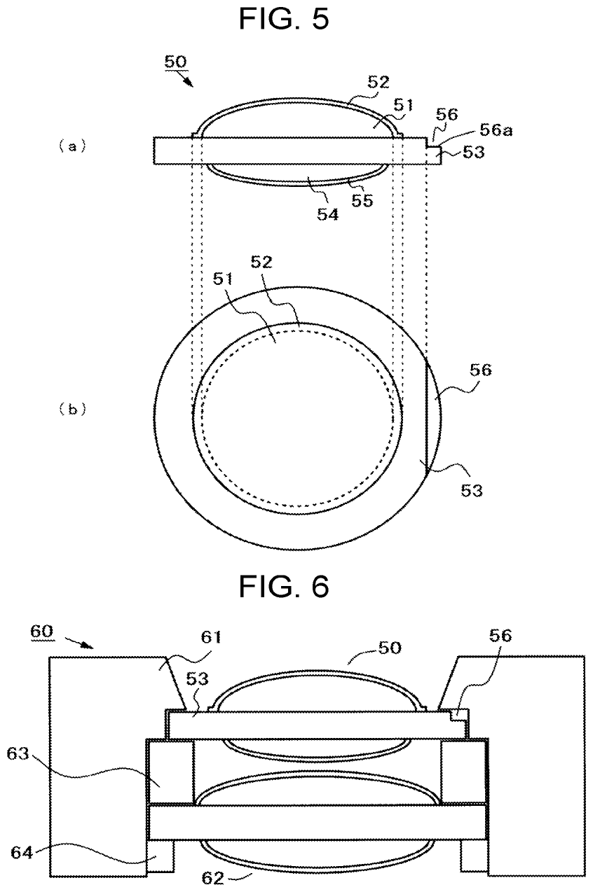

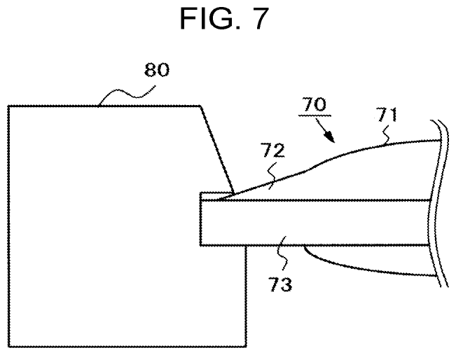

FIG. 5 is a view showing an optical element 50 according to a third embodiment. (a) of FIG. 5 is a cross-sectional view and (b) of FIG. 5 is a plan view of the optical element 50 viewed from above.

The optical element 50 is a lens element made of glass. The optical element 50, in a central portion thereof, includes a first curved part (optical function part) 51 having a convex shape, and a second curved part (optical function part) 54, which faces the first curved part 51. A surface of the first curved part 51 is covered with an antireflection film 52. A surface of the second curved part 54 is covered with an antireflection film 55.

The optical element 50 includes a flange 53 disposed outside the optical function part. The antireflection film 52 also covers a part of the flange 53. In this embodiment, the antireflection film 52 may not cover the flange 53. Furthermore, the antireflection film 52 lying on the flange 53 may be absent. In this embodiment, a direction indication part 56 is formed on the flange 53. In the example shown in FIG. 5, the direction indication part 56 is formed by forming a cutout in an outermost portion of the flange 53. The antireflection film 52 may be formed on the direction indication part 56.

In this embodiment, in the surface of the flange 53 (including both the portion covered with the antireflection film 52 and the portion not covered therewith), the portion which is not covered with the antireflection film 52 includes a non-cutout portion and a cutout portion, i.e., a bottom surface 56a of the direction indication part 56. The direction indication part 56 is formed such that the region in the surface of the flange 53 which is not covered with the antireflection film 52 and which does not include the bottom surface 56a of the direction indication part 56 accounts for 60% or more of the surface of the flange 53. Although the direction indication part 56 shown in FIG. 5 is a recess formed in an outermost portion of the flange 53, the direction indication part 56 may not be formed in an outermost portion of the flange 53. That is, the direction indication part 56 may be formed in a portion other than outermost portion of the flange 53 as long as the region of the flange 53 which does not include the direction indication part 56 accounts for 60% or more of the surface of the flange 53 and as the worker can visually recognize the direction indication part 56. Although the direction indication part 56 shown as an example in FIG. 5 is a cutout having a quadrilateral cross-sectional shape, the cross-sectional shape of the direction indication part 56 may not be quadrilateral.

It is thought that in the case where the proportion of the region is 60% or higher, flange-surface flatness can be maintained. It is preferable that the thickness (depth) of the direction indication part 56 is, for example, 2 μm or less such that no tilt is caused in the flange surface even if the direction indication part 56 comes into contact with other members (e.g., the lens barrel, a surface of the flange of another lens element, and a spacer element) in assembling a lens unit. The flange 53 is formed such that the surface thereof is flat. In other words, it is hence preferable that the difference in surface level between the direction indication part 56 (specifically, the bottom surface 56a of the direction indication part 56) and the flat portion (flange surface) is 2 μm or less.

Although the direction indication part 56 shown as an example in FIG. 5 is one formed by cutting out a portion of a doughnut-shaped flange 53 along a straight line in the plan view, the shape of the direction indication part 56 is not limited thereto. The direction indication part 56 may have another shape as long as the proportion of the region in the surface of the flange 53 which is not covered with the antireflection film 52 and which does not include the upper surface of the direction indication part 56 is 60% or higher and as the worker can visually recognize the direction indication part 56.

FIG. 6 is a cross-sectional view showing a lens unit 60 including a lens barrel 61 and the optical element 50 incorporated thereinto. The lens unit 60 shown in FIG. 6 includes both the optical element 50 and another lens 62. The optical element 50 is held by the lens barrel 61 and a spacer 63. The lens 62 is held by the lens barrel 61, the spacer 63, and a fastener 64. In FIG. 6, the optical element 50 and the lens 62 are shown as if these are separated from the lens barrel 61 and the spacer 63. Actually, however, the flange 53 of the optical element 50 and the flange of the lens 62 are each in contact with the inner wall of the lens barrel 61. The flange 53 of the optical element 50 is also in contact with the spacer 63. The flange of the lens 62 is also in contact with the fastener 64.

The optical element 50 is to be positioned when the flange 53 comes into contact with the lens barrel 61, etc. The worker understands the circumferential-direction attachment position of the optical element 50 on the basis of the direction indication part 56. Since the flange surface has sufficient flatness in incorporating the optical element 50 into the lens barrel 61 as described above, the flange surface is inhibited from being tilted.

The optical elements 10, 30, and 50 shown above as examples in the first to the third embodiments include second curved parts 14, 34, and 54 having a convex shape toward an outer side. However, the second curved parts 14, 34, and 54 may be flat or recessed.

Embodiments and examples of the optical element were explained above, and the optical elements shown as the embodiments and examples can be applied to (for example, incorporated into) various optical systems.

Examples of the optical systems include lenses which cooperate with the optical element, optical filters such as antireflection films and bandpass filters, cover glasses, and diaphragms. However, these are merely examples, and applications in which the optical element is usable are not limited to those examples.

The optical element described above is supposed to be applied to imaging devices, e.g., cameras.

While the invention has been described in detail and with reference to specific embodiments thereof, it will be apparent to one skilled in the art that various changes and modifications can be made therein without departing from the spirit and scope thereof.

This application is based on Japanese patent application No. 2018-083225 filed on Apr. 24, 2018, the contents thereof being incorporated herein by reference.

### INDUSTRIAL APPLICABILITY

The optical element in the present invention is inhibited from decreasing in flange-surface flatness even when the optical element comes into contact with other members. The present invention, which has this effect, is useful with respect to optical elements, optical systems, and imaging devices.

### REFERENCE SIGNS LIST

10, 30, 50 Optical element
11, 31, 51 First curved part
12, 32, 52 Antireflection film
13, 33, 53 Flange
14, 34, 54 Second curved part
15, 35, 55 Antireflection film
16, 36, 56 Direction indication part
20, 40, 60 Lens unit
21, 41, 61 Lens barrel
22, 42, 62 Another lens
23, 43, 63 Spacer
24, 44, 64 Fastener

1. An optical element, comprising:
an optical function part;
a flange disposed outside the optical function part; and
a direction indication part in a part of the flange,
wherein a difference in level between the direction indication part and a flat surface of the flange is 2 μm or less.

2. The optical element according to claim 1, wherein:
the optical function part and a part of the flange are covered with an antireflection film; and
the direction indication part is formed as a protruding portion of the antireflection film.

3. The optical element according to claim 1, wherein:
the optical function part and a part of the flange are covered with an antireflection film; and
the direction indication part is formed as a cutout of the antireflection film.

4. The optical element according to claim 1, wherein the direction indication part is a recess formed in the flange.

5. The optical element according to claim 1, wherein in a front side of the flange, a flat region of the flange accounts for 60% or more of an entire surface of the flange.

6. The optical element according to claim 2, wherein 60% or more of an entire surface of the flange is not covered with the antireflection film.

7. The optical element according to claim 3, wherein 60% or more of an entire surface of the flange is covered with the antireflection film.

8. The optical element according to claim 4, wherein a region of the flange that does not include the direction indication part accounts for 60% or more of an entire surface of the flange.

9. The optical element according to claim 1, being a lens element made of glass.

10. An optical system comprising the optical element according to claim 1.

11. An imaging device comprising the optical element according to claim 1.
